(19) United States
(12) Patent Application Publication
(10) Pub. No.: US 2022/0080342 A1
(43) Pub. Date: Mar. 17, 2022

(54) FILTER MATERIAL USED FOR AUTOMOBILE AIR CONDITIONING AND CAPABLE OF FILTERING OUT VOLATILE ORGANIC COMPOUND (VOC) GAS, AND PROCESS THEREOF

(71) Applicant: ZHEJIANG JIAHAI NEW MATERIALS CO., LTD., Haining (CN)

(72) Inventor: Jianhua Xia, Haining (CN)

(21) Appl. No.: 17/295,636

(22) PCT Filed: Jun. 5, 2020
(86) PCT No.: PCT/CN2020/094515

§ 371 Date: Nov. 22, 2021

(30) Foreign Application Priority Data
Jun. 5, 2019 (CN) 201910484410.0

(51) Int. Cl. B01D 39/18; B01D 39/16; B01D 39/20; B32B 5/26; B32B 7/14; B32B 5/02

(52) U.S. Cl. CPC B01D 39/18; B32B 2262/0253; B01D 39/2065; B32B 5/271; B32B 5/266; B32B 7/14; B32B 5/022; B32B 5/268; B01D 2239/025; B01D 2239/10; B01D 2239/0618; B01D 2239/0636; B01D 2239/0668; B01D 2239/0672; B01D 2239/0627; B01D 2239/0216; B01D 2239/0407; B32B 2262/106; B32B 2262/0292; B32B 2262/04; B32B 2307/718; B32B 2605/08; B32B 2250/04; B32B 2250/20; B01D 39/163

(57) ABSTRACT

The present disclosure provides a filter material used for automobile air conditioning and capable of filtering out volatile organic compound (VOC) gas, including a sandwich structure (100) and an activated carbon fiber (ACF) non-woven fabric layer (200) located at one side of the sandwich structure (100), where, the ACF non-woven fabric layer (200) is composed of interleaved ACFs, and the ACF non-woven fabric layer (200) is compounded with the sandwich structure (100) via hot melt adhesive (HMA) (210).

### CROSS-REFERENCE TO RELATED APPLICATIONS

The present application claims priority to International Application No. PCT/CN2020/094515, filed on Jun. 5, 2020, which claims priority to the Chinese Patent Application No. 201910484410.0, filed to the China National Intellectual Property Administration (CNIPA) on Jun. 5, 2019 and entitled “FILTER MATERIAL USED FOR AUTOMOBILE AIR CONDITIONING AND CAPABLE OF FILTERING OUT VOLATILE ORGANIC COMPOUND (VOC) GAS, AND PROCESS THEREOF”, both of which are incorporated herein by reference in its entirety.

### TECHNICAL FIELD

The present disclosure relates to the technical field of filter materials, and in particular to a filter material used for automobile air conditioning and capable of filtering out volatile organic compound (VOC) gas, and a process thereof.

### BACKGROUND

Filter materials for automobile air conditioning currently on the market can not only filter out PM 2.5, but also adsorb VOC gas. The VOC gas is one of the most common air pollutants in non-industrial environments, and common VOCs include styrene, propylene glycol (PG), larane, phenol, toluene, ethylbenzene, xylene, formaldehyde, and so on.

Traditionally, VOC gas is adsorbed by activated carbon particles. Currently, filter materials for automobile air conditioning on the market include nanofiber membranes. A nanofiber membrane, after compounded with activated carbon particles, will be pierced and damaged by the activated carbon particles during subsequent processing, so that the filtering performance of the composite filter material will be reduced or lost.

### SUMMARY

### I. The Technical Problem to be Solved

The present disclosure needs to solve the problem that the filtering performance of a composite filter material will be reduced or lost due to the damage of activated carbon particles to a nanofiber membrane during subsequent processing.

### II. Technical Solution

In order to solve the technical problem, the present disclosure provides a filter material used for automobile air conditioning and capable of filtering out VOC gas, and a process thereof. The filter material has excellent gas permeability, high VOC gas-adsorbing capacity, and prominent PM 2.5-filtering capacity.

The present disclosure provides a filter material used for automobile air conditioning and capable of filtering out VOC gas, including a sandwich structure 100 and an activated carbon fiber (ACF) non-woven fabric layer 200 located at one side of the sandwich structure 100, where, the ACF non-woven fabric layer 200 is composed of interleaved ACFs, and the ACF non-woven fabric layer 200 is compounded with the sandwich structure 100 via hot melt adhesive (HMA) 210.

Further, the sandwich structure 100 includes a viscose fiber non-woven fabric layer 110, a thermoplastic polyurethane (TPU) nanofiber layer 120, and a polypropylene (PP) long fiber non-woven fabric layer 130; and the TPU nanofiber layer 120 is located at one side of the viscose fiber non-woven fabric layer 110, the PP long fiber non-woven fabric layer 130 is located at the other side of the TPU nanofiber layer 120, and the ACF non-woven fabric layer 200 is located at the other side of the PP long fiber non-woven fabric layer 130.

Further, the PP long fiber non-woven fabric layer 130, the TPU nanofiber layer 120, and the viscose fiber non-woven fabric layer 110 may form the sandwich structure 100 by a compounding method.

Further, the HMA 210 is uniformly distributed between the sandwich structure 100 and the ACF non-woven fabric layer 200 in a dot-like, fibrous, or linear form.

Further, the ACF non-woven fabric layer 200 may have a weight of 50 GSM/m² to 500 GSM/m².

Further, the viscose fiber non-woven fabric layer 110 may be located at a windward side, and the ACF non-woven fabric layer 200 may be located at a wind-out side.

The present disclosure also provides a fabrication method of the filter material used for automobile air conditioning and capable of filtering out VOC gas, including:

a. fabricating the viscose fiber non-woven fabric layer 110;

b. fabricating the TPU nanofiber layer 120;

c. fabricating the PP long fiber non-woven fabric layer 130;

d. subjecting the viscose fiber non-woven fabric layer 110, the TPU nanofiber layer 120, and the PP long fiber non-woven fabric layer 130 to thermal compounding or ultrasonic compounding to form the sandwich structure 100;

e. fabricating the ACF non-woven fabric layer 200;

f. via the HMA, compounding the fabricated ACF non-woven fabric layer 200 with the sandwich structure 100 formed by subjecting the viscose fiber non-woven fabric layer 110, the TPU nanofiber layer 120, and the PP long fiber non-woven fabric layer 130 to thermal compounding or ultrasonic compounding; and

g. subjecting a finished filter material to quality inspection and trimming, and finally storing the filter material in a warehouse.

Further, in the fabrication method of the filter material used for automobile air conditioning and capable of filtering out VOC gas provided in the present disclosure, the HMA 210 used in the step f for compounding may be uniformly distributed in a dot-like, fibrous, or linear form.

### III. Beneficial Effects

1. The present disclosure adopts the ACF non-woven fabric layer 200 instead of activated carbon particles because ACFs have a stronger VOC gas 430 adsorption capacity than activated carbon particles. ACFs are fabricated into a non-woven fabric to prevent an ACF layer from damaging the TPU nanofiber layer. Moreover, the compounding of the ACF non-woven fabric layer 200 with the sandwich structure 100 is conducted in the last to avoid the problem that the TPU nanofiber layer 120 will be damaged due to other processes conducted after the compounding.

2. The present disclosure adopts the sandwich structure 100, where, the TPU nanofiber layer 120 is arranged between the viscose fiber non-woven fabric layer 110 and the PP long fiber non-woven fabric layer 130 to avoid damage to the TPU nanofiber layer 120 to the greatest extent. Moreover, the PP long fiber non-woven fabric layer 130 is arranged between the TPU nanofiber layer 120 and the ACF non-woven fabric layer 200 to prevent the TPU nanofiber layer 120 from being damaged due to the contact of the TPU nanofiber layer 120 with the ACF non-woven fabric layer 200.

3. The ACF non-woven fabric layer 200 of the present disclosure, located at a wind-out side, can filter out the VOC gas 430 outside an automobile and can also adsorb the VOC gas 430 generated inside the automobile, so that the air 400 inside the automobile is fresh.

4. The viscose fiber non-woven fabric layer 110 of the present disclosure is located at a windward side to block external foreign matters, thus preventing the TPU nanofiber layer 120, the PP long fiber non-woven fabric layer 130, and the ACF non-woven fabric layer 200 from being damaged.

5. In the present disclosure, the ACF non-woven fabric layer 200 is used instead of the original activated carbon particles to compound with the sandwich structure 100, and the ACF non-woven fabric layer is affixed to the sandwich structure 100 using a glue material, which solves the problem that activated carbon particles have a greatly-reduced surface area and a reduced VOC gas 430 adsorption capacity after being wrapped by the glue material.

### BRIEF DESCRIPTION OF THE DRAWINGS

FIG. 1 is a schematic structural diagram of the filter material;

FIG. 2 is a schematic structural diagram of the ACF non-woven fabric layer;

FIG. 3 is a schematic structural diagram of the HMA with dot-like distribution;

FIG. 4 is a schematic structural diagram of the HMA with fibrous distribution;

FIG. 5 is a schematic structural diagram of the HMA with linear distribution; and

FIG. 6 is a schematic diagram of a filtration process of the filter material.

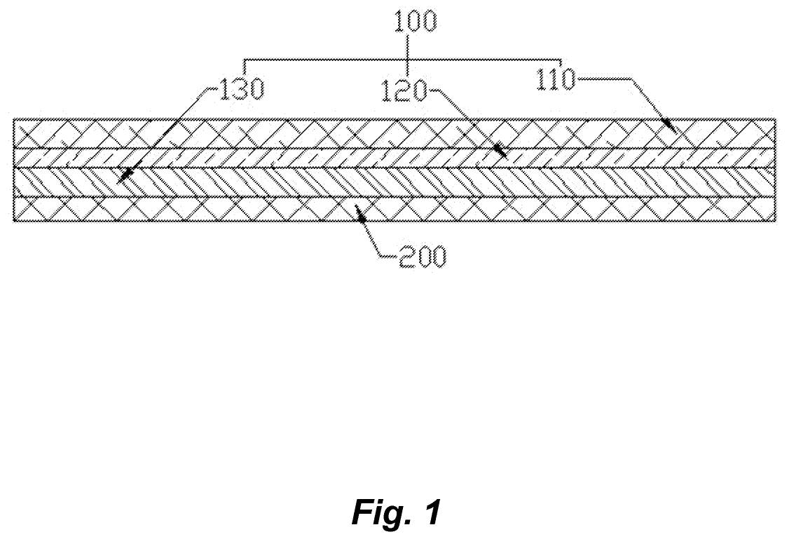

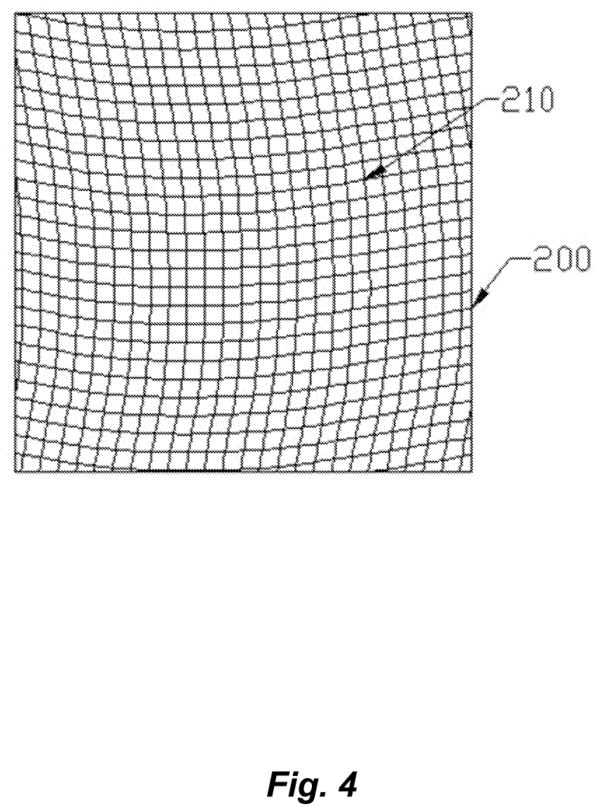

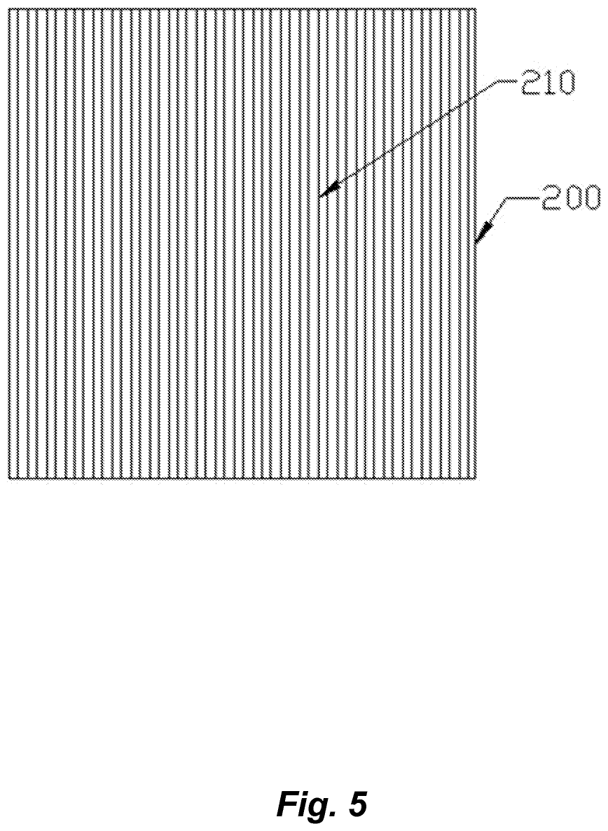

In FIG. 1 to FIG. 6, 100 represents a sandwich structure; 110 represents a viscose fiber non-woven fabric layer; 120 represents a TPU nanofiber layer; 130 represents a PP long fiber non-woven fabric layer; 200 represents an ACF non-woven fabric layer; 210 represents HMA; 300 represents foreign matters; 400 represents air; 410 represents particles with a diameter of 1 μm or more; 420 represents particles with a diameter of less than 1 μm; and 430 represents VOC gas.

### DETAILED DESCRIPTION

The specific implementations of the present disclosure are further described in detail below with reference to examples. The following examples are intended to illustrate the present disclosure, rather than to limit the scope of the present disclosure.

As shown in FIG. 1, a filter material used for automobile air conditioning and capable of filtering out VOC gas includes a sandwich structure 100 and an ACF non-woven fabric layer 200 located at one side of the sandwich structure 100, where, the ACF non-woven fabric layer 200 is compounded with the sandwich structure 100 via HMA 210. The sandwich structure 100 is configured to block and adsorb particulate matters in the air 400, and the ACF non-woven fabric layer 200 is configured to adsorb VOC gas 430 in the air, thus removing peculiar smell and reducing the content of VOC gas 430 inhaled by people in an automobile.

As shown in FIG. 1, the sandwich structure 100 includes a viscose fiber non-woven fabric layer 110, a TPU nanofiber layer 120, and a PP long fiber non-woven fabric layer 130. The viscose fiber non-woven fabric layer 110 is a basal layer configured to carry and protect the TPU nanofiber layer 120 and the PP long fiber non-woven fabric layer 130; the TPU nanofiber layer 120 is configured to filter out and block particles 410 with an average diameter of 1 μm or more in the air 400; and the PP long fiber non-woven fabric layer 130 is configured to adsorb the remaining particles 420 with a diameter of less than 1 μm in the air 400 after the filtration. The TPU nanofiber layer 120 is located at one side of the viscose fiber non-woven fabric layer 110, the PP long fiber non-woven fabric layer 130 is located at the other side of the TPU nanofiber layer 120, and the ACF non-woven fabric layer 200 is located at the other side of the PP long fiber non-woven fabric layer 130. Specifically, the PP long fiber non-woven fabric layer 130, the TPU nanofiber layer 120, and the viscose fiber non-woven fabric layer 110 form the sandwich structure 100 by a compounding method. The sandwich structure 100 is adopted so that the viscose fiber non-woven fabric layer 110 and the PP long fiber non-woven fabric layer 130 can well protect the fragile TPU nanofiber layer 120.

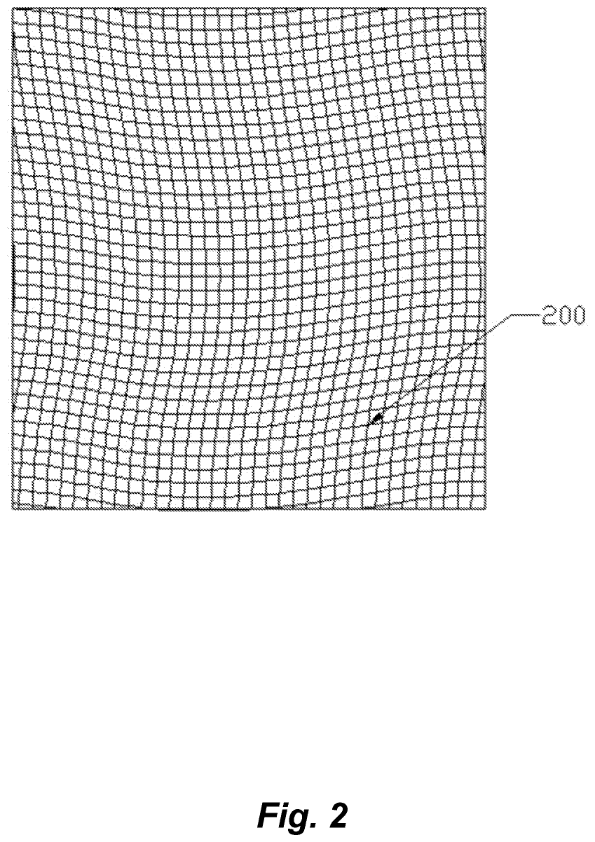

As shown in FIG. 2, the ACF non-woven fabric layer 200 is composed of interleaved ACFs. Specifically, the ACF non-woven fabric layer 200 has a weight of 50 GSM/m² to 500 GSM/m², so that the ACF non-woven fabric layer 200 has both high capacity to adsorb the VOC gas 430 in the air and excellent gas permeability.

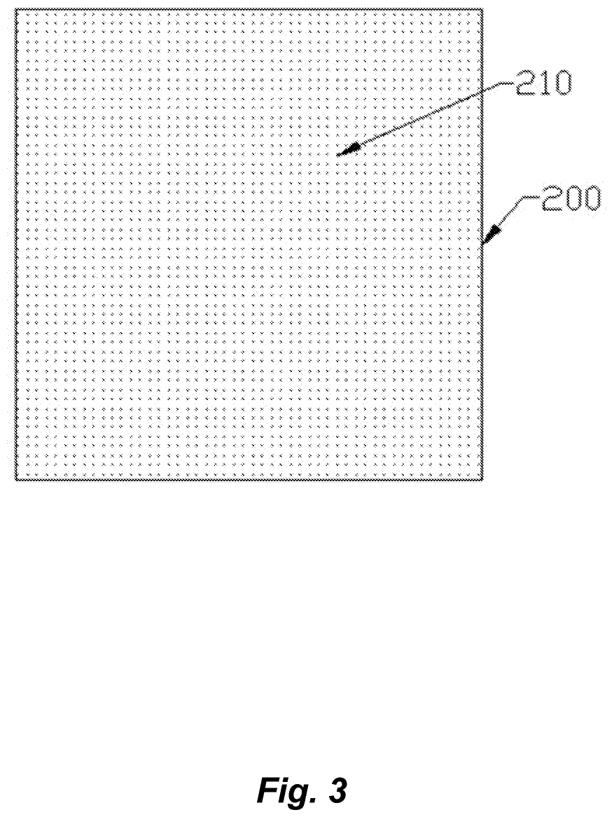

As shown in FIG. 3 to FIG. 5, the HMA 210 is uniformly distributed between the sandwich structure 100 and the ACF non-woven fabric layer 200 in a dot-like, interleaved fibrous, or linear form to compound the sandwich structure 100 with the ACF non-woven fabric layer 200. As tested, a filter material obtained by compounding the sandwich structure with the ACF non-woven fabric layer 200 shows a static adsorption efficiency of more than 40% to toluene and an adsorption efficiency of more than 90% to formaldehyde.

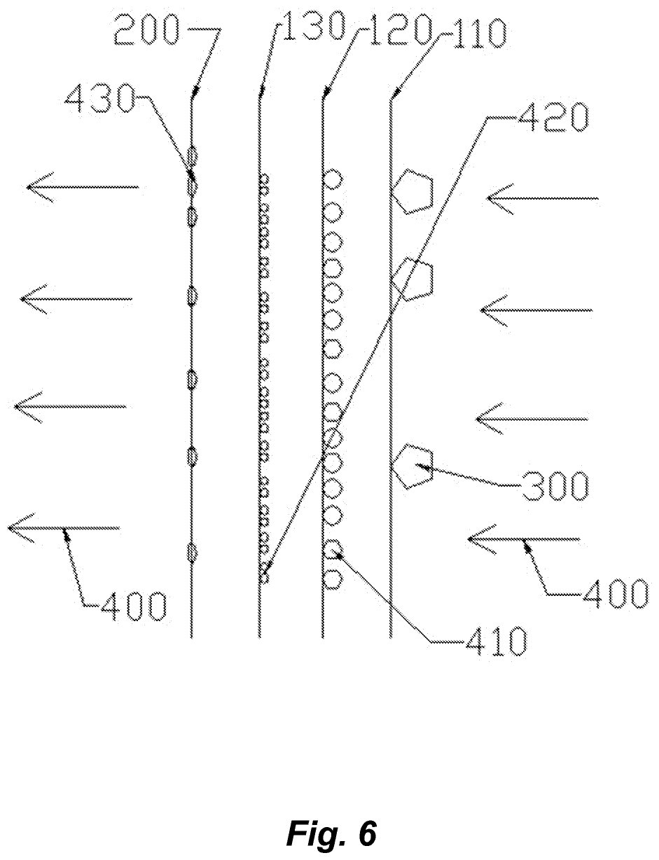

As shown in FIG. 6, the viscose fiber non-woven fabric layer 110 is located at a windward side to ward off wind and prevent foreign matters 300 from damaging the filter material, thereby protecting the entire filter material; and the ACF non-woven fabric layer 200 is located at a wind-out side to adsorb the VOC gas 430, which facilitates the adsorption of the VOC gas 430 in the filtered air 400 in an automobile by the ACF non-woven fabric layer.

As shown in FIG. 6, when in use, the viscose fiber non-woven fabric layer 110 blocks foreign matters 300, which are garbage and/or pebbles, and the air 400 passes through the viscose fiber non-woven fabric layer 110 to contact the TPU nanofiber layer 120 so that particles 410 with an average diameter of 1 μm or more are filtered out; the filtered air 400 passes through the TPU nanofiber layer 120 to contact the PP long fiber non-woven fabric layer 130 so that particles 420 with a diameter of less than 1 μm in the air are adsorbed by the PP long fiber non-woven fabric layer 130, and the air 400 passes through the PP long fiber non-woven fabric layer 130 to contact the ACF non-woven fabric layer 200; and when the air 400 passes through the ACF non-woven fabric layer 200, due to gap among ACFs, most of the VOC gas 430 in the air 400 is adsorbed on the ACFs, and the remaining air 400 enters the interior of the automobile.

Moreover, the VOC gas 430 in the air 400 inside an automobile will also be slowly adsorbed by the ACF non-woven fabric layer 200, thereby allowing the air 400 inside the automobile to be fresh and odorless.

A fabrication method of the filter material used for automobile air conditioning and capable of filtering out VOC gas provided in the present disclosure includes the following steps:

a. A viscose fiber non-woven fabric layer 110 is fabricated.

Viscose fibers are fabricated into a non-woven fabric by spun-bonding, which will be used as a basal layer for a filter material, and then the viscose fiber non-woven fabric layer 110 is calendared by a calendar roll to ensure that the surface to be attached with a TPU nanofiber layer 120 is smooth.

b. A TPU nanofiber layer 120 is fabricated.

A TPU granular resin is mixed with a mixed solvent of N,N-dimethylformamide (DMF) and methyl ethyl ketone (MEK) in a closed container to obtain a TPU solution, and the TPU nanofiber layer 120 is fabricated from the TPU solution by a nanofiber membrane fabrication device. The viscose fiber non-woven fabric layer 110 and the TPU nanofiber layer 120 are pressed by a calendar roll to form a two-layer composite structure.

c. APP long fiber non-woven fabric layer 130 is fabricated.

The PP long fiber non-woven fabric layer 130 is fabricated from a PP polymer resin by a melt-blown device.

d. The viscose fiber non-woven fabric layer 110, the TPU nanofiber layer 120, and the PP long fiber non-woven fabric layer 130 are subjected to thermal compounding or ultrasonic compounding to form a sandwich structure 100.

e. An ACF non-woven fabric layer 200 is fabricated.

The ACF non-woven fabric layer 200 is fabricated from ACFs by spun-lacing so that the non-woven fabric layer has excellent gas permeability.

f. The fabricated ACF non-woven fabric layer 200 is coated with HMA 210 in a dot-like, interleaved fibrous, or linear form and then compounded with the sandwich structure 100 formed by subjecting the viscose fiber non-woven fabric layer 110, the TPU nanofiber layer 120, and the PP long fiber non-woven fabric layer 130 to thermal compounding or ultrasonic compounding, so as to form a four-layer structure, where, the ACF non-woven fabric layer 200 is located at an outer side of the PP long fiber non-woven fabric layer 130.

g. A finished filter material is subjected to quality inspection and trimming, and finally stored in a warehouse.

A section was cut off from each roll of filter material, and the ability to filter out and adsorb particles and the ability to adsorb VOC gas 430 are tested by a common test method. After the test, irregular edges produced at two sides due to compounding are trimmed for qualified filter materials, and the filter materials are then stored in rolls.

In summary, the above examples are not restrictive implementations of the present disclosure. Any modification or equivalent variation made by those skilled in the art on the basis of the essence of the present disclosure falls within the technical scope of the present disclosure.

1. A filter material used for automobile air conditioning and capable of filtering out volatile organic compound (VOC) gas, comprising a sandwich structure (100) and an activated carbon fiber (ACF) non-woven fabric layer (200) located at one side of the sandwich structure (100), wherein, the ACF non-woven fabric layer (200) is composed of interleaved ACFs, and the ACF non-woven fabric layer (200) is compounded with the sandwich structure (100) via hot melt adhesive (HMA) (210);
the sandwich structure (100) comprises a viscose fiber non-woven fabric layer (110), a thermoplastic polyurethane (TPU) nanofiber layer (120), and a polypropylene (PP) long fiber non-woven fabric layer (130); and the TPU nanofiber layer (120) is located at one side of the viscose fiber non-woven fabric layer (110), the PP long fiber non-woven fabric layer (130) is located at one side of the TPU nanofiber layer (120), and the ACF non-woven fabric layer (200) is located at one side of the PP long fiber non-woven fabric layer (130).

2. The filter material used for automobile air conditioning and capable of filtering out VOC gas according to claim 1, wherein, the PP long fiber non-woven fabric layer (130), the TPU nanofiber layer (120), and the viscose fiber non-woven fabric layer (110) form the sandwich structure (100) by a compounding method; and
the compounding method is thermal compounding or ultrasonic compounding.

3. The filter material used for automobile air conditioning and capable of filtering out VOC gas according to claim 1, wherein, the HMA (210) is uniformly distributed between the sandwich structure (100) and the ACF non-woven fabric layer (200) in a dot-like, fibrous, or linear form.

4. The filter material used for automobile air conditioning and capable of filtering out VOC gas according to claim 1, wherein, the ACF non-woven fabric layer (200) has a weight of 50 GSM/m² to 500 GSM/m².

5. The filter material used for automobile air conditioning and capable of filtering out VOC gas according to claim 1, wherein, the viscose fiber non-woven fabric layer (110) is located at a windward side, and the ACF non-woven fabric layer (200) is located at a wind-out side.

6. A fabrication method of filter material used for automobile air conditioning and capable of filtering out volatile organic compound (VOC) gas, comprising the following steps:
a. fabricating a viscose fiber non-woven fabric layer (110);
b. fabricating a thermoplastic polyurethane (TPU) nanofiber layer (120);
c. fabricating a polypropylene (PP) long fiber non-woven fabric layer (130);
d. subjecting the viscose fiber non-woven fabric layer (110), the TPU nanofiber layer (120), and the PP long fiber non-woven fabric layer (130) to thermal compounding or ultrasonic compounding to form a sandwich structure (100);
e. fabricating an activated carbon fiber (ACF) non-woven fabric layer (200);
f. compounding the fabricated ACF non-woven fabric layer (200) with the sandwich structure (100) via a hot melt adhesive (HMA) (210), wherein, the ACF non-woven fabric layer (200) is located at an outer side of the PP long fiber non-woven fabric layer 130; and
g. subjecting a finished filter material to quality inspection and trimming, and finally storing the filter material in a warehouse;
wherein, the steps a, b, and c can be conducted in any order, and the steps a, b, c, and d can be conducted either before or after the step e.

7. The fabrication method of the filter material used for automobile air conditioning and capable of filtering out VOC gas according to claim 6, wherein, the HMA (210) used in the step f for compounding is uniformly distributed in a dot-like, fibrous, or linear form.

8. The fabrication method of the filter material used for automobile air conditioning and capable of filtering out VOC gas according to claim 6, wherein, the step a comprises the following substeps:
fabricating viscose fibers into a non-woven fabric by spun-bonding, and calendaring the non-woven fabric with a calendar roll.

9. The fabrication method of the filter material used for automobile air conditioning and capable of filtering out VOC gas according to claim 6, wherein, the step b comprises the following steps:
mixing a TPU granular resin with a mixed solvent of N-dimethylformamide (DMF) and methyl ethyl ketone (MEK) in a closed container to obtain a TPU solution, and fabricating the TPU nanofiber layer (120) from the TPU solution by a nanofiber membrane fabrication device.

10. The fabrication method of the filter material used for automobile air conditioning and capable of filtering out VOC gas according to claim 6, wherein, the step c comprises the following step:
fabricating the PP long fiber non-woven fabric layer (130) from a PP polymer resin by a melt-blown device.

11. The fabrication method of the filter material used for automobile air conditioning and capable of filtering out VOC gas according to claim 6, wherein, the step e comprises the following step:
fabricating the ACF non-woven fabric layer (200) from ACFs by spun-lacing.

12. The fabrication method of the filter material used for automobile air conditioning and capable of filtering out VOC gas according to claim 6, wherein the PP long fiber non-woven fabric layer (130), the TPU nanofiber layer (120), and the viscose fiber non-woven fabric layer (110) form the sandwich structure (100) by a compounding method; and
the compounding method is thermal compounding or ultrasonic compounding.

13. The fabrication method of the filter material used for automobile air conditioning and capable of filtering out VOC gas according to claim 6, wherein the ACF non-woven fabric layer (200) has a weight of 50 GSM/m² to 500 GSM/m².

14. The fabrication method of the filter material used for automobile air conditioning and capable of filtering out VOC gas according to claim 6, wherein the viscose fiber non-woven fabric layer (110) is located at a windward side, and the ACF non-woven fabric layer (200) is located at a wind-out side.

15. A fabrication method of filter material used for automobile air conditioning and capable of filtering out volatile organic compound (VOC) gas according to claim 1, comprising the following steps:
a. fabricating a viscose fiber non-woven fabric layer (110);
b. fabricating a thermoplastic polyurethane (TPU) nanofiber layer (120);
c. fabricating a polypropylene (PP) long fiber non-woven fabric layer (130);
d. subjecting the viscose fiber non-woven fabric layer (110), the TPU nanofiber layer (120), and the PP long fiber non-woven fabric layer (130) to thermal compounding or ultrasonic compounding to form a sandwich structure (100);
e. fabricating an activated carbon fiber (ACF) non-woven fabric layer (200);
f. compounding the fabricated ACF non-woven fabric layer (200) with the sandwich structure (100) via a hot melt adhesive (HMA) (210), wherein, the ACF non-woven fabric layer (200) is located at an outer side of the PP long fiber non-woven fabric layer 130; and
g. subjecting a finished filter material to quality inspection and trimming, and finally storing the filter material in a warehouse;
wherein, the steps a, b, and c can be conducted in any order, and the steps a, b, c, and d can be conducted either before or after the step e.

16. The fabrication method of the filter material used for automobile air conditioning and capable of filtering out VOC gas according to claim 15, wherein, the PP long fiber non-woven fabric layer (130), the TPU nanofiber layer (120), and the viscose fiber non-woven fabric layer (110) form the sandwich structure (100) by a compounding method; and
the compounding method is thermal compounding or ultrasonic compounding.

17. The fabrication method of the filter material used for automobile air conditioning and capable of filtering out VOC gas according to claim 15, wherein, the HMA (210) is uniformly distributed between the sandwich structure (100) and the ACF non-woven fabric layer (200) in a dot-like, fibrous, or linear form.

18. The fabrication method of the filter material used for automobile air conditioning and capable of filtering out VOC gas according to claim 15, wherein, the ACF non-woven fabric layer (200) has a weight of 50 GSM/m² to 500 GSM/m².

19. The fabrication method of the filter material used for automobile air conditioning and capable of filtering out VOC gas according to claim 15, wherein, the viscose fiber non-woven fabric layer (110) is located at a windward side, and the ACF non-woven fabric layer (200) is located at a wind-out side.

20. The fabrication method of the filter material used for automobile air conditioning and capable of filtering out VOC gas according to claim 15, wherein, the step a comprises the following substeps:
fabricating viscose fibers into a non-woven fabric by spun-bonding, and calendaring the non-woven fabric with a calendar roll.
